(19) United States
(12) Patent Application Publication
(10) Pub. No.: US 2018/0374269 A1
(43) Pub. Date: Dec. 27, 2018

(54) AUGMENTED REALITY AND VIRTUAL REALITY MOBILE DEVICE USER INTERFACE AUTOMATIC CALIBRATION

(71) Applicant: INVRSE Reality Limited, Seattle, WA (US)

(72) Inventor: Ryan Smith, Seattle, WA (US)

(21) Appl. No.: 16/015,120

(22) Filed: Jun. 21, 2018

Related U.S. Application Data
(60) Provisional application No. 62/523,079, filed on Jun. 21, 2017.

(51) Int. Cl. G06T 19/00; G06T 7/73; G06K 7/14; G06K 7/10

(52) U.S. Cl. CPC G06T 19/006; G06T 7/74; G06T 2210/56; G06K 7/1413; G06K 7/10722; G06K 7/1417

(57) ABSTRACT

A system for automatic calibration and recalibration of multiple point clouds in a head mounted display device and a mobile device utilizes the display of the mobile device to act as a reference point for the head mounted display to identify a position of the mobile device within a three-dimensional space. Thereafter, the mobile device's own positional tracking capabilities may maintain the mobile device's position, and report it back to the head mounted display, subject to periodic updates and recalibrations when the mobile device display again comes into view of an outward-facing camera of the head mounted display.

### RELATED APPLICATION INFORMATION

This patent claims priority from U.S. provisional patent application Ser. No. 62/523,079 filed Jun. 21, 2017 and entitled “VR/AR User Interface and Tracking.”

### NOTICE OF COPYRIGHTS AND TRADE DRESS

A portion of the disclosure of this patent document contains material which is subject to copyright protection. This patent document may show and/or describe matter which is or may become trade dress of the owner. The copyright and trade dress owner has no objection to the facsimile reproduction by anyone of the patent disclosure as it appears in the Patent and Trademark Office patent files or records, but otherwise reserves all copyright and trade dress rights whatsoever.

### BACKGROUND

### Field

This disclosure relates to augmented reality and virtual reality environments and, more particularly, to integration of a mobile device or images based upon a physical location of a mobile device, into augmented reality and virtual reality environments.

### Description of the Related Art

Numerous systems exist for enabling virtual and augmented reality experiences for individuals. Most notably, there are at least two, major manufacturers and suppliers of very high-quality virtual reality headsets, namely the Oculus® Rift® and the HTC® Vive® head mounted displays (and associated systems). These systems are integrated with hand-held remote controls or controllers that enable functionality such as button-based interactions and, typically, positional tracking of a user's hands.

For example, the Oculus Rift controllers incorporate a series of infrared lights along their exterior that may be used by an external camera or cameras to track the position and, generally, the orientation of a user's hands while holding the controller. As a result, a user may “punch” or “wave” or perform other actions and the action may be detected by those cameras and integrated into an ongoing augmented reality or virtual reality experience. Due to the complex and computationally intense nature of these systems, they presently rely upon external computers to perform three-dimensional rendering and to generally perform the motion and positional tracking.

On the other end of the spectrum, numerous augmented and virtual reality head mounted display systems exist that are reliant upon inserting one's mobile device into a headset or other holder. The mobile device then becomes the processor and display for that virtual reality or augmented reality system. This is relatively simple, because all of these devices integrate cameras, a display, and positional tracking and motion tracking hardware (e.g. inertial measurement units—IMU). Still more modern mobile devices also incorporate sophisticated infrared and point cloud systems. Though these systems are typically based upon mobile-device technology (e.g. processors and displays and IMUs), they may be free operating or operate “as” a standalone headset without any external computer while incorporating some more complex cameras or LIDAR point cloud systems.

However, these devices often do not incorporate or operate in conjunction with remote controls. Or, if they do, the controls are relatively low-functioning. They typically provide only button-based interaction and, potentially, some thumb sticks for movement within the virtual reality or augmented reality environment.

The goal in the near-term for augmented reality and virtual reality headsets is to merge these two experiences. Ideally, the head mounted display would be fully-integrated, and not reliant upon any external computer (e.g. a desktop or laptop computer), while still maintaining a high level of visual fidelity and quality motion and positional tracking. As mobile devices have become more and more powerful, this goal has increasingly become within reach. There are systems or forthcoming systems from several manufacturers that operate extremely well without any external computers. These systems often incorporate outward-facing infrared or LIDAR cameras to help with depth mapping in addition to the more-traditional IMU to continuously recalibrate the headset's position within the world. Some systems rely upon optical cameras only, likely in stereoscopy (or multiple sets of stereoscopic cameras) to enable similar depth mapping functionality. The benefit of these types of systems is that the technology (cameras) is ubiquitous, high-quality, and relatively inexpensive compared to infrared or LIDAR based systems.

Integrating controllers with these systems has proven expensive. One goal is to push the prices of these systems lower so as to foster large scale adoption. In furtherance of that, controllers are in many cases “optional” components. When components are made optional, software developers must operate on the understanding that the hardware will not be present. Some of the more sophisticated systems can use the infrared cameras and projectors or the LIDAR systems to detect, with a high degree of fidelity, hand movements, positions, and locations. As a result, in the best of cases, controllers are not necessary.

However, for some functions, a controller or hand-held device is extremely helpful, if not necessary. It would be beneficial if there were an easily-available, cross-platform controller with extremely high-fidelity motion tracking and that is capable of operating in various environments and with various capabilities for use in augmented reality and virtual reality environments.

### DESCRIPTION OF THE DRAWINGS

FIG. 1 is a system diagram for a system of mobile device calibration.

FIG. 2 is a block diagram of a computing device 200.

FIG. 3 is a functional diagram for a system of mobile device calibration.

FIG. 4 is a flowchart for superimposing overlays on mobile device displays within an augmented reality or virtual reality environment.

FIG. 5 is a flowchart for a process of enabling interaction within an augmented reality or virtual reality environment.

FIG. 6 is a flowchart for a process of calibrating a mobile device's position within an augmented reality or virtual reality environment.

FIG. 7 is an example head mounted display within a three-dimensional environment.

FIG. 8 is an example of a head mounted display detecting a machine-readable image on a mobile device.

FIG. 9 is an example of a head mounted display superimposing an image over a mobile device within an augmented reality or virtual reality environment.

FIG. 10 is an example of a head mounted display integrating a mobile device into a point cloud.

FIG. 11 is an example of updating a point cloud for a head mounted display using motion data from a mobile device.

Throughout this description, elements appearing in figures are assigned three-digit reference designators, where the most significant digit is the figure number and the two least significant digits are specific to the element. An element that is not described in conjunction with a figure may be presumed to have the same characteristics and function as a previously-described element having a reference designator with the same least significant digits.

### DETAILED DESCRIPTION

Description of Apparatus

Referring now to

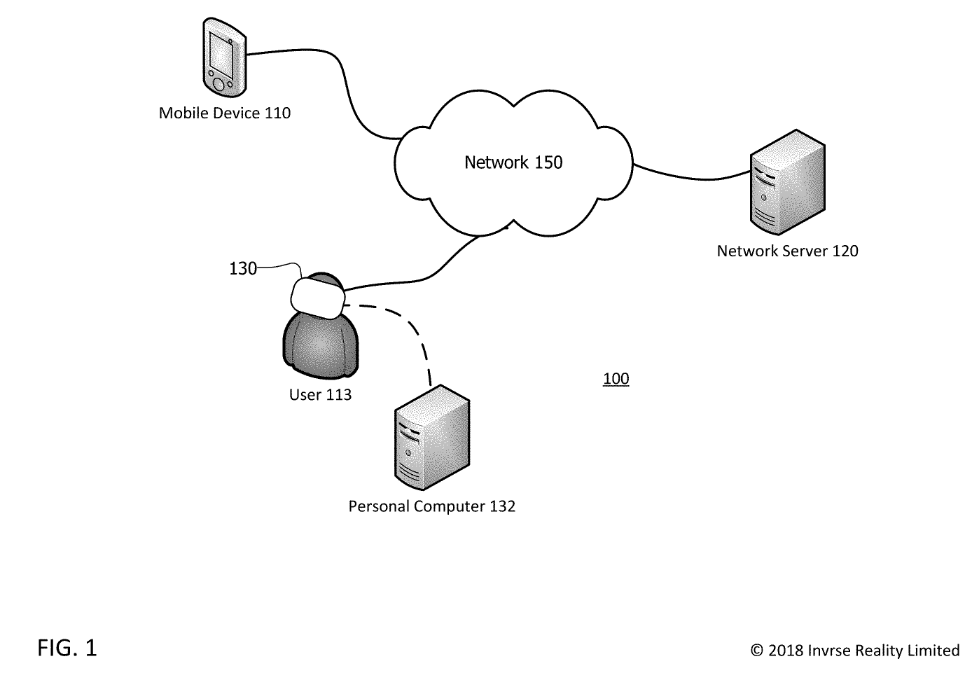

FIG. 1 is a system diagram for a system 100 of mobile device calibration. The system 100 includes a mobile device 110, a network server 120 and a head mounted display 130, in this case, on the face of a user 113. The system may, optionally, include a personal computer 132. All of the system 100 may be interconnected using a network 150.

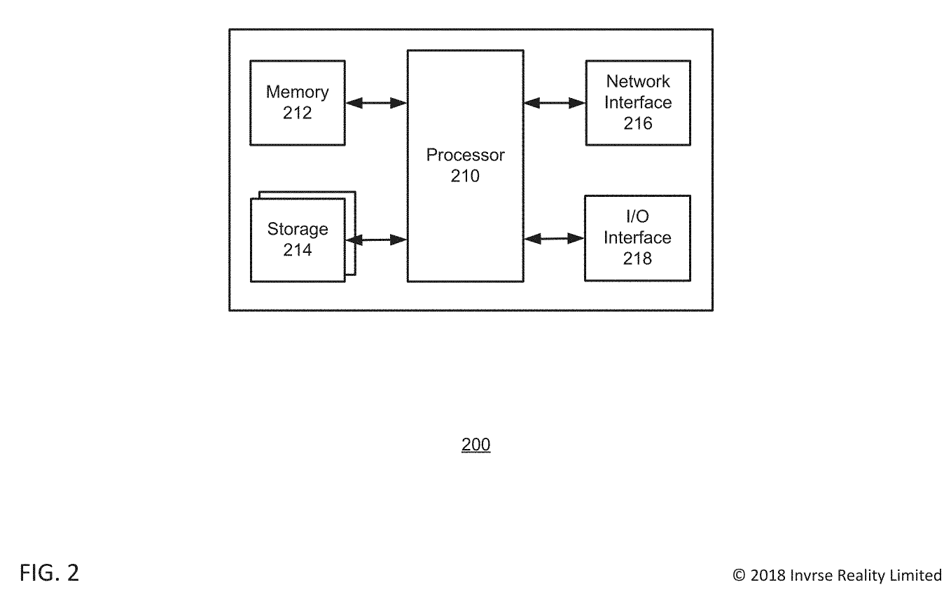

The mobile device 110 is a computing device (FIG. 2). The mobile device is preferably an integrated handset incorporating a processor, memory, a display with touchscreen capabilities, at least rudimentary motion capabilities and, more preferably, an inertial measurement unit (IMU), and may optionally include a camera. The mobile device has an operating system and is capable of displaying images on the display as it chooses, when using software, or at the direction of an external device, such as the head mounted display 130.

The network server 120 is a computing device and incorporates an operating system. It is an optional component in the sense that it is not required for functionality described herein. However, should multiple head mounted displays be integrated into a single game or augmented reality or virtual reality experience, a network server 120 may provide network infrastructure to enable that interaction in connection with software operating on the respective head mounted display 130 for each user. The network server 120 may in fact be multiple computing devices linked or otherwise integrated so as to provide functionality for many users. The network server 120 may, for example, be a part of a scalable, commercial or private, “cloud computing” infrastructure.

The head mounted display 130 is a computing device with an associated operating system. The head mounted display 130 is shown as an integrated augmented reality or virtual reality headset including a processor, memory, a display, an IMU, one or more cameras, and optional other hardware as well. However, the head mounted display 130 may be dependent upon a personal computer 132 (which is also a computing device), in whole or in part, in some implementations to perform some of the functions described herein.

Although the system preferably has one or more cameras, in some cases no cameras may be provided or available. In such cases, tracking may take place reliant upon the mobile device 110 tracking the head mounted display 130 when it is visible to one or more of the cameras in the mobile device 110. This will be discussed more fully below.

The head mounted display 130 is shown as a head mounted display, but it may be a head mounted display in the sense that it is actually a mobile device, placed inside a suitable case or holder so as to “act” as a head mounted display for a limited time.

The network 150 is a computer network interconnecting the various components such that they may exchange information and data with one another.

Turning now to FIG. 2 a block diagram of a computing device 200 is shown, which is representative of the mobile device 110, the head mounted display 130, the personal computer 132, and the network server 120 in FIG. 1. The computing device 200 may be, for example, a desktop or laptop computer, a server computer, a tablet, a smartphone, virtual reality headset or device, augmented reality headset or device, or other mobile device. The computing device 200 may include software and/or hardware for providing functionality and features described herein. The computing device 200 may therefore include one or more of: logic arrays, memories, analog circuits, digital circuits, software, firmware and processors. The hardware and firmware components of the computing device 200 may include various specialized units, circuits, software and interfaces for providing the functionality and features described herein. For example, a global positioning system (GPS) receiver or similar hardware may provide location-based services.

The computing device 200 has a processor 210 coupled to a memory 212, storage 214, a network interface 216 and an I/O interface 218. The processor 210 may be or include one or more microprocessors, field programmable gate arrays (FPGAs), graphics processing units (GPUs), holographic processing units (HPUs), application specific integrated circuits (ASICs), programmable logic devices (PLDs) and programmable logic arrays (PLAs).

Though shown as a single processor 210, the processor 210 may be or include multiple processors. For example, GPUs and HPUs in particular may be incorporated into a computing device 200. A GPU is substantially similar to a central processing unit, but includes specific instruction sets designed for operating upon three-dimensional data. GPUs also, typically, include built-in memory that is oftentimes faster and includes a faster bus than that for typical CPUs. An HPU is similar to a GPU, but further includes specialized instruction sets for operating upon mixed-reality data (e.g. simultaneously processing a video image of a user's surroundings so as to place augmented reality objects within that environment, and for processing three-dimensional objects or rendering so as to render those objects in that environment).

The processor 210 may also be or include one or more inertial measurement units (IMUs) that are in common use within mobile devices and augmented reality or virtual reality headsets. IMUs typical incorporate a number of motion and position-based sensors such as gyroscopes, gravitometers, accelerometers, and other, similar sensors, then output positional data in a form suitable for use by other processors or integrated circuits.

The memory 212 may be or include RAM, ROM, DRAM, SRAM and MRAM, and may include firmware, such as static data or fixed instructions, BIOS, system functions, configuration data, and other routines used during the operation of the computing device 200 and processor 210. The memory 212 also provides a storage area for data and instructions associated with applications and data handled by the processor 210. As used herein the term “memory” corresponds to the memory 212 and explicitly excludes transitory media such as signals or waveforms

The storage 214 provides non-volatile, bulk or long-term storage of data or instructions in the computing device 200. The storage 214 may take the form of a magnetic or solid state disk, tape, CD, DVD, or other reasonably high capacity addressable or serial storage medium. Multiple storage devices may be provided or available to the computing device 200. Some of these storage devices may be external to the computing device 200, such as network storage or cloud-based storage. As used herein, the terms “storage” and “storage medium” correspond to the storage 214 and explicitly exclude transitory media such as signals or waveforms. In some cases, such as those involving solid state memory devices, the memory 212 and storage 214 may be a single device.

The network interface 216 includes an interface to a network such as network 150 (FIG. 1). The network interface 216 may be wired or wireless. Examples of network interface 216 may be or include cellular, 802.11x, Bluetooth®, Zigby, infrared, or other wireless network interfaces. Network interface 216 may also be fiber optic cabling, Ethernet, switched telephone network data interfaces, serial bus interfaces, like Universal Serial Bus, and other wired interfaces through which computers may communicate one with another.

The I/O interface 218 interfaces the processor 210 to peripherals (not shown) such as displays, holographic displays, virtual reality headsets, augmented reality headsets, video and still cameras, infrared cameras, LIDAR systems, microphones, keyboards and USB devices such as flash media readers.

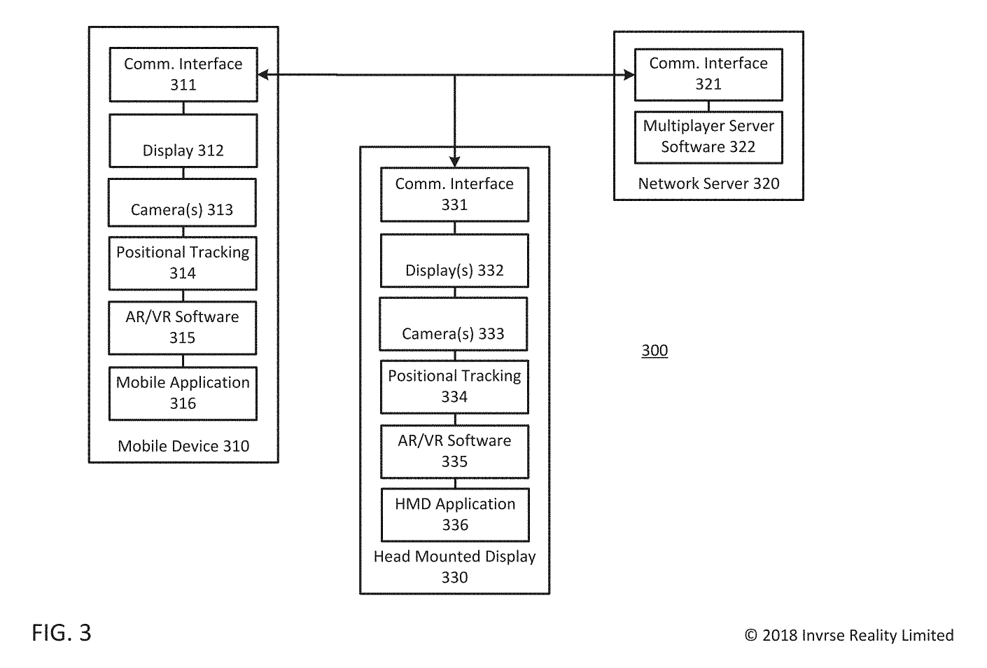

FIG. 3 is a functional diagram for a system of mobile device calibration. FIG. 3 includes the mobile device 310, the network server 320, and the head mounted display 330 of FIGS. 1 (110, 120, and 130, respectively). However, in FIG. 3, these computing devices are shown as functional, rather than hardware, components.

The mobile device 310 includes a communications interface 311, a display 312, one or more camera(s) 313, positional tracking 314, augmented reality or virtual reality software 315, and one or more mobile applications 316.

The communications interface 311 is responsible for enabling communications between the mobile device 310 and the head mounted display 330. The communications interface 311 may be wired or wireless, may incorporate known protocols such as the Internet protocol (IP), and may rely upon 802.11x wireless or Bluetooth or some combination of those protocols and other protocols. The communications interface 311 enables the mobile device 310 to share information on the network 150 (FIG. 1).

The display 312 may be one or more displays, but is capable of displaying images and video on the mobile device 310. The display typically is close to the full front or full side of a mobile device. The display 312 may operate at the direction of the mobile device 310 or may operate as directed by the head mounted display 330.

The camera(s) 313 may be one or more cameras. The camera(s) 313 may use stereoscopy, infrared, and/or LIDAR to detect the position and orientation, relative to the mobile device 310's surroundings. The camera(s) 313 may be still or video cameras and may incorporate projectors or illuminators in order to function (e.g. infrared illumination or LIDAR laser projections).

The positional tracking 314 may be the IMU, discussed above, but also may incorporate specialized software and/or hardware that integrates data from the camera(s) 313 and any IMU or similar positional, orientational, or motion-based tracking performed separately by the mobile device 310 into a combined, whole, positional, motion and orientational dataset. That dataset may be delivered to the mobile device 310 (or to the head mounted display 330, suing the communications interface 311) on a regular basis by the positional tracking 314.

The AR/VR software 315 is augmented reality or virtual reality software operating upon the mobile device 310. The software 315 may act as a “viewer” that a user may look through to see augmented reality or virtual realty content. Or, alternatively, the software 315 may operate as an extension of corresponding AR/VR software 335 operating on the head mounted display 330 to generate, for example, a machine-readable image on the display 312 so that the AR/VR software 335 operating on the head mounted display 330 may superimpose an augmented reality object or user interface over the display 312.

The mobile application 316 may be a game, communications application, or other mobile application that incorporates some augmented reality or virtual reality content, for example, using the AR/VR software 315. Or, the mobile application 316 may be a stand-alone software application that performs some function for the mobile device 310.

The network server 320 includes a communications interface 321 and multiplayer server software 322. The communications interface 321 is substantially similar to that of the mobile device 310 except that the network server 320's communications interface 321 is designed to accept and to communicate with numerous computing devices simultaneously. As such, it may be substantially larger and specifically designed for simultaneous communication with many such devices.

The multiplayer server software 322 is software designed to communication and to enable communications between multiple mobile device 310s and head mounted display 330s. As discussed above, the network server 320 may be optional. However, when it is present, it may be used for mass communications and synchronization of data between multiple client applications operating on the mobile device 310s and head mounted display 330s.

The head mounted display 330 includes a communications interface 311, one or more display(s) 332, one or more camera(s) 333, positional tracking 334, augmented reality or virtual reality software 335, and one or more mobile applications 336. The functions of each of these components are substantially the same as those for the corresponding components of the mobile device 310 and that will not be repeated here except to the extent that there are differences.

The head mounted display 330 may incorporate one or more display(s) 332, for example one for each eye of a user wearing the head mounted display 330. Though this is generally disfavored for synchronization purposes, it is possible and does increase the overall pixel density for displays.

Likewise, there may be multiple camera(s) 333 provided on the head mounted display 330. These cameras may face in several different directions, but are generally arranged so as to provide overlapping, but wide fields of view to enable the infrared, LIDAR or even video cameras to continually track movement of the headset, relative to a wall or other characteristics of the exterior world.

Positional tracking 334 may integrate IMU information with information from multiple camera(s) 333 so as to very accurately maintain positional, orientational, and motion data for the head mounted display 330 to ensure that augmented reality or virtual reality software 335 operates upon the best possible data available to the head mounted display 330.

The HMD application 336 may be substantially the same as the mobile application 316, except that the HMD application 336 may operate to control the mobile device 310 functions to enable the mobile device 310 to operate as an extension of the head mounted display 330, for example, to operate as a controller thereof.

Description of Processes

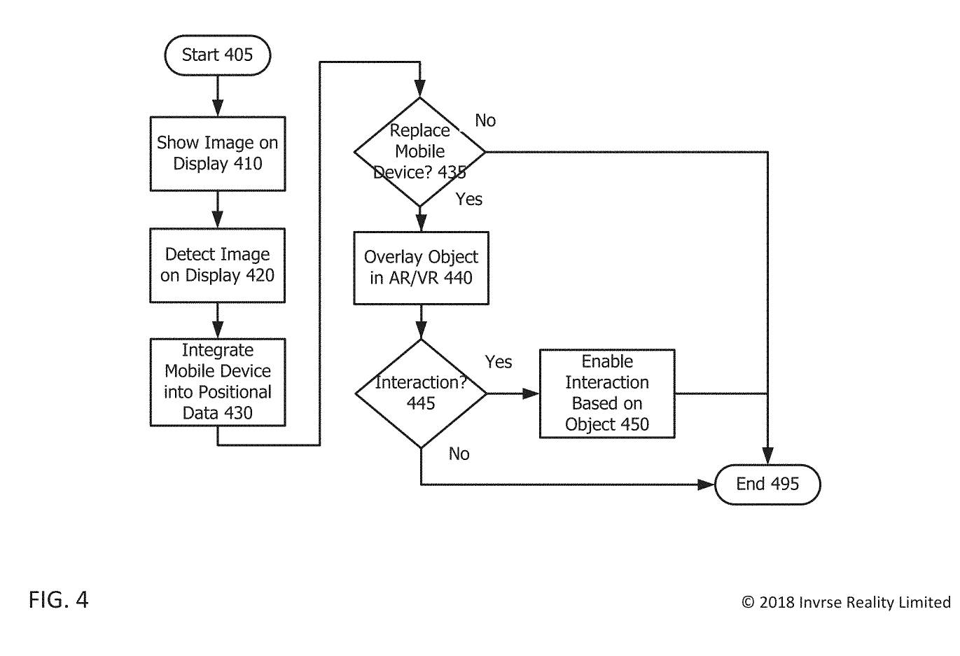

Referring now to FIG. 4, a flowchart for superimposing overlays on mobile device displays within an augmented reality or virtual reality environment is shown. The process has a start 405 and an end 495, but may be iterative or may take place many times in succession.

After the start 405, the process begins by showing an image on the display 410 of the mobile device. This image may be, for example, a QR code or similar image that is suitable for being machine readable. Bar codes, recognizable shapes, large, blocks of images with high contrast (e.g. black and white) are preferable. There are many types of images that may be suitable. In some cases, the image shown may be merely an image associated with suitable mobile device software, such as a logo or a particular screen color scheme or orientation. The image may overtly appear to be machine readable like a QR code or may be somewhat hidden, for example integrated into a useable, human-readable interface.

It should be noted that this display of the image at 410 may be substantially hidden from the user of the mobile device. A single frame of video or only one image shown every few seconds as quickly as the display can refresh to show the machine-readable image, and re-refresh to show the typical display may be all that is necessary for the head mounted display to take note of the position of the mobile device showing the image on the display at 410. In such cases, this step may take place on the order of milliseconds, largely imperceptible to a human using the mobile device. This momentary display of the image may be timed such that the head mounted display and the mobile device are both aware of the timing of the image so that the head mounted display may be ready or looking for the image on the mobile device display at a pre-determined time within the ordinary display of the mobile device. In this way, the image-based calibration or detection may be used while not interrupting the normal operation of the mobile device while within augmented reality. This may facilitate augmented reality systems by enabling a user to continue seeing other information or another application shown on the display of the mobile device.

The image may be dynamic such that it changes from time to time. The image itself may be used to communicate information between the mobile device and the head mounted display, including information about position or orientation. The information may be a set of reference points or a shared reference point.

The image may also be dynamic such that it is capable of adapting to different use cases. So, for example, when the mobile device is relatively still (as detected by an IMU in the mobile device), the displayed image may be relatively complex and finely-grained. However, when the IMU detects rapid movement of the mobile device or that the mobile device is about to come into view of the head mounted display, but only briefly, it may alter the image to be of a “lower resolution,” thereby decreasing the amount of visual fidelity in the image or increasing the block size of black and white blocks in, for example, a QR code functioning as the image. In this way, the image may be briefly more-easily detectable by exterior-facing cameras of the head mounted display, even though the mobile device is moving quickly or may only briefly be within view of the head mounted display. This dynamic shifting of the size or other characteristics of the image (or the user interface itself including a hidden machine-readable image) may enable the system to more-accurately calibrate or re-calibrate each time the display of the mobile device is visible, where using the same “high resolution” image each time may not be recognizable for very short periods of time or during rapid mobile device movement.

The display should be within view of one or more cameras of the head mounted display for this process to function appropriately.

Next, the image is detected by the head mounted display as shown on the mobile device's display at 420. This detection may rely upon the machine-readable image to be perceived by one or more cameras. In this detection process, the orientation, angle, and amount of the image that are visible are also detected. In that way, the head mounted display can simultaneously realize the location of the mobile device's display, and the mobile device's angle or orientation. That additional data will be helpful in integrating the mobile device into positional data below.

At 430, the mobile device's position, orientation, and movement are integrated into the positional data of the head mounted display. At this stage, the information gleaned from the detection of the machine-readable image shown on the display in 410 is used to generate a point cloud or other three-dimensional model of the mobile device in the integrated positional data (for example, a set of points within the point cloud specifically for the mobile device) of the head mounted display. In this way, the mobile device may have characteristics such as depth, position of the display, angle of the display, and its overall three-dimensional model represented as a point cloud within the data of the head mounted display.

At 440, a determination is made whether the augmented reality or virtual reality software, or whether any other head mounted display software wishes to replace the mobile device 435 in the images shown on the head mounted display. So, for example, in an augmented reality environment, the mobile device may be “replaced” visually with another object (or overlaid over the mobile device), such as a tennis racket, a golf club, a light saber, or giant, oversized hands. The same may be true in a virtual reality environment. Because the positional and orientation data have been integrated, and may continually be integrated, into the point cloud or other three-dimensional model of the area surrounding the head mounted display (maintained by the head mounted display), it may be replaced intelligently.

Continued positional tracking, either using the image displayed on the screen, or other IMU data or a combination of both (discussed below) may enable ongoing interaction with the “replaced” or overlaid object. This may be, for example, a tennis match, a golf game, an in-VR or in-AR high five, or the like.

If the mobile device is not to be replaced (“no” at 435), then this detection process may end at end 495.

If the mobile device is to be replaced (“yes” at 435), then the overlay object may be superimposed over the mobile device in the augmented reality or virtual reality environment at 440. This overlay may completely cover the mobile device or may account for occlusions of part of the display of the mobile device to appear somewhat more intelligent and accurate to life (e.g. the hand may be visible on the grip of a tennis racket).

Likewise, the system may enable interaction with the overlaid object at 445 if that is desired. If it is not desired (“no” at 445), then the process may end. If interaction is desired (“yes” at 445), then associated code may enable interaction based upon the object at 450. This interaction may make it possible to swing the tennis racket and to hit a virtual tennis ball in the AR or VR experience. Or, this interaction may make it possible to swing a sword and thereby “cut” objects within the AR or VR world. These interactions will be object specific, and a user may have a say in what object is overlaid over his or her mobile device. Or, the AR or VR experience itself may dictate from a list of available objects for superimposition.

In another example, a menu system may be superimposed over the mobile device at 440. In such a case, a series of buttons, or interactive elements may appear to be “on” the display of the mobile device, whether or not they are actually on the mobile device display. Or, the buttons or other interactive elements may appear to “hover” over the display of the mobile device, on its back, or anywhere in relation to the mobile device. Interactions with these virtual user interfaces may be enabled at 450.

Thereafter, the process ends at 495.

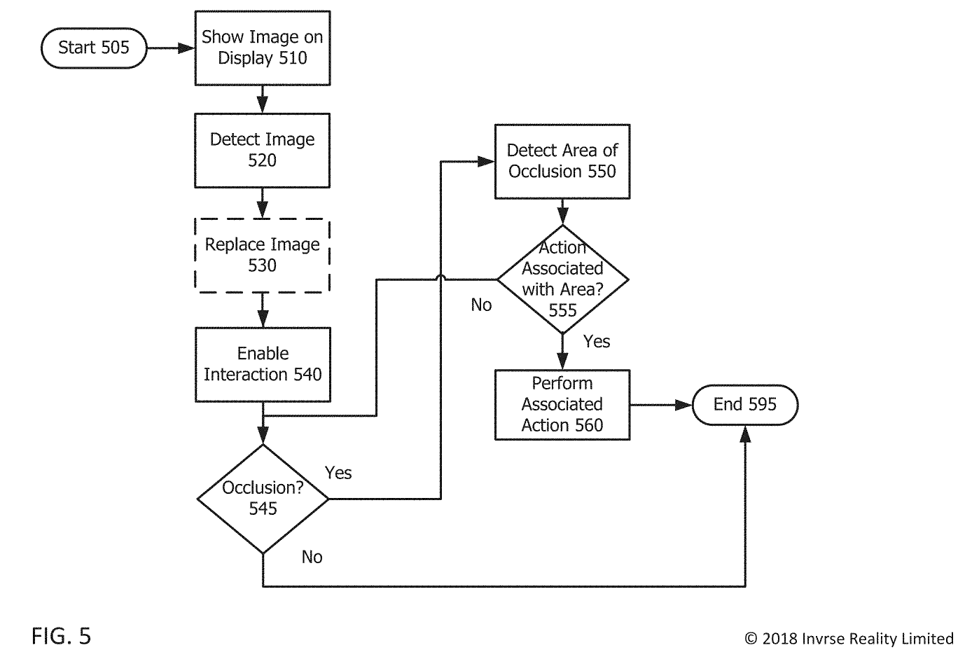

Turning now to FIG. 5, a flowchart for a process of enabling interaction within an augmented reality or virtual reality environment is shown. The process has a start 505 and an end 595, but may be iterative or may take place many times in succession.

After the start 505, an image is shown on the display 510. This image is substantially as described above with respect to element 410.

The image may be detected at 520 in much the same way it is detected with respect to element 420.

Here, the image may or may not be replaced at 530. The replacement is optional because it may be helpful for the user interface of the mobile device itself to continue being seen. And, through communication between the mobile device and the head mounted display, user interactions may be tracked and take place, causing changes in either or both of the head mounted display or the mobile device.

Whether or not the image is replaced, interaction with the mobile device itself, or the image either superimposed on the display or hovering over the display may be enabled at 540 such that user interaction with the display may cause actions to take place in the augmented reality or virtual reality environment or otherwise in the mobile device or other computing devices reachable (e.g. by a network connection) by the mobile device or the head mounted display.

At 545, a determination is made whether occlusion is detected. If no occlusion is detected (“no” at 545), then the process can end at 595.

If occlusion is detected (“yes” at 545), then the area of the occlusion may be detected at 550. The detection of the occlusion may take place in a number of ways. First, outward-facing cameras from the head mounted display may detect that a part of an image shown on the display (e.g. a machine-readable image) has been made invisible or undetectable. This is because when most of such an image is visible, the head mounted display still understands what the “whole” image should look like and can detect an incomplete image. This “blocking” of the image from view may act as an occlusion, indicating user interaction with the display of the mobile device and the location of that interaction.

Or, this occlusion may be detected using depth sensors (e.g. infrared cameras) on the exterior of the head mounted display or front-facing cameras or infrared cameras on the mobile device. In this sense, the occlusion is not necessarily actual occlusion, but interaction “in space” with an object that may be overlaid on top of the mobile device or at a position in space relative to the mobile device (or projected interface or object based upon the position of the mobile device) that is associated with an interaction. For example, this may be a menu or series of buttons floating “in space” or it may be a pull lever or bow string on a bow, or virtually any device one can imagine.

This process detects the area of occlusion at 550, then determines whether that area is associated with any action at 555. If not (“no” at 555), then the process may return to occlusion detection at 545. If an action is associated with that area (“yes” at 555), then the associated action may be performed at 560. The action may be “pulling” the lever, pulling back a bow string, swinging a tennis racket, or otherwise virtually any interaction with the “space” relative to the mobile device.

Thereafter, the process may end at 595.

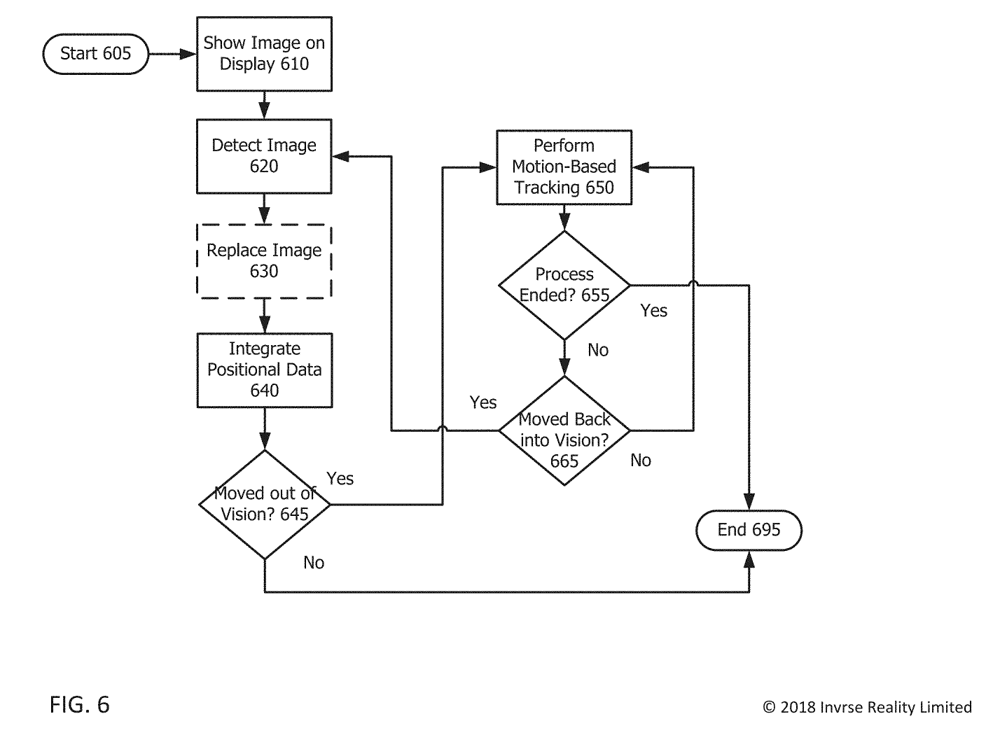

Referring now to FIG. 6, a flowchart for a process of calibrating a mobile device's position within an augmented reality or virtual reality environment. The process has a start 605 and an end 695, but may be iterative or may take place many times in succession.

After the start 605, the process begins with showing an image on the display 610 of the mobile device. This process is described above with respect to step 410 in FIG. 4 and will not be repeated here. with the detection of the image at 620 and replacement of the image at 630 are similar to those described in, for example, FIG. 4, elements 420, and 430, above.

At 640, after detection of the image and any optional replacement of the image, the positional, movement, rotational, and other characteristics of the mobile device are integrated into the positional data of the head mounted display. Ideally, the head mounted display continuously generates a point cloud for its surrounding environment. The point cloud acts as a wireframe of the exterior world, enabling the head mounted display to very accurately update itself with its position relative to three-dimensional objects in the world.

The mobile device is capable of performing similar functions, but typically lacks the high-quality depth sensors that may be used on a head mounted display. As a result, the mobile device is generally capable of generating adequate motion and position information for itself, but its sensors are of lesser quality. Any positional data it generates is in its own “frame of reference” which is distinct from that of the head mounted display.

A typical method of synchronizing two sets of point clouds is to share a subset of point clouds either bi-directionally, or unidirectionally, then compare the two clouds to one another to perform spatial matching computations, and then the software comes to a consensus about the most-likely shared points (or three-dimensional shapes) between the two devices. Unfortunately, point clouds are rather high-density data. While this happens, each device is generating high-density data in rapid succession, potentially many times per second. So, by the time the data is shared, and a consensus is reached by one or both devices, both devices have likely moved from that position. As a result, synchronization of these two frames of reference is difficult.

At step 640, the display of the mobile device is detected by cameras of the head mounted display. The display's orientation (e.g. an angle of the display relative to the head mounted display) can be easily ascertained and estimated. Then, the mobile device may be integrated as a three-dimensional object within the head mounted display's point cloud. A corresponding frame of reference may be shared (e.g. a difference between the mobile device's frame of reference and the head mounted display's frame of reference) by the head mounted display to the mobile device.

In this way, the mobile device's position, relative to the head mounted display (or, more accurately, its frame of reference) may be quickly ascertained and maintained. In this way, the two devices may be calibrated (or, more accurately, their frames of reference may be calibrated such that they are shared), relative to one another. The devices may share a small bit of data orienting one another (or both) to a reference point or points for the combined or shared frame of reference.

Thereafter, the mobile device display may move out of view of the head mounted display at 645. If this does not happen (“no” at 645), then the process may end at 695.

If the device does move out of the vision of the head mounted display cameras (“yes” at 645), then the mobile device, and the head mounted display, are still capable of maintaining their shared frame of reference because the mobile device is capable of performing motion-based tracking at 650.

At this stage, the mobile device may be, for example, swung behind a user's head as he or she prepares to hit a virtual or augmented reality tennis ball. The display of the mobile device is not visible to the camera(s) of the head mounted display, but the mobile device has an integrated IMU or more-basic positional tracking sensors. However, the system may rely upon those sensors to perform self-tracking and to report those movements as best it is able back to the head mounted display to provide a reasonable approximation of its location. This data may be transmitted by a network connection between the mobile device and the head mounted display. That data set is a relatively easy and compact data set to share once the devices have a shared point cloud space with a shared frame of reference. The data set may be as simple as a set of translations of a center point for the mobile device and a rotation.

If the process is over at that point (“yes” at 655), then the process ends. However, if the process is not ended (“no” at 655), and the device does not move back into vision (“no” at 665), the motion-based tracking and updating continues at 650.

If the display of the mobile device does move back into vision (“yes” at 655), then the process may again detect the image at 620. However, this time, the mobile device and the head mounted display will re-integrate positional data at 640 with some baseline understanding of each relative frame of reference. Inevitably, when performing motion-based tracking, there is some inaccuracy, and inherently these systems incorporate “drift” by which wrong data builds upon wrong data self-extrapolates into very inaccurate positional information. As a result, in the prior art, IMU-based position systems typically must be re-calibrated after some time of use without some “baseline” established.

In this system, the relative position of the two devices may periodically, and automatically, be recalibrated based upon times when the mobile device display is visible to the head mounted display cameras. Each time the mobile device moves into view of the head mounted display cameras, the two devices may be able to recalibrate and share the same three-dimensional frames of reference in a shared point cloud.

Using this system, the mobile device may be used as a controller, or as a device over which other augmented reality or virtual reality objects are overlaid while still enabling that overly to be accurate over long periods of interaction with or without any outward-looking positional tracking system in place on the mobile device, simply by automatically, and periodically coordinating the two devices within the shared, same three-dimensional space.

Though described with respect to the head mounted display tracking and orientating itself with respect to the mobile device using an image displayed on the mobile device, the same is possible for the mobile device to track a headset using a similarly displayed image (or other unique aspects of the head mounted display like shape, visible or infrared lighting, etc.). In the case of a display—and the display need not be particularly high-quality—the images shown may enable the mobile device to operate as the “owner” of the three-dimensional space or point cloud. When the head mounted display is within vision of one or more of the cameras in the mobile device, it may operate in much the same way to integrate the head mounted display into the mobile device's point cloud or map of the three-dimensional space. Then, the mobile device may share that frame of reference with the head mounted display. This is particularly helpful for augmented reality or virtual reality head mounted displays that lack or do not make use of external cameras. In these cases, many of the same functions may be completed with the roles of the mobile device and the head mounted display reversed to arrive at a shared three-dimensional space or point cloud.

Likewise, images shown on either the head mounted display or the mobile device may be dynamic such that they may continuously share reference point information as data within a machine-readable image on the face of each and corresponding cameras on both devices may read this information to more-closely calibrate one another within a shared three-dimensional space.

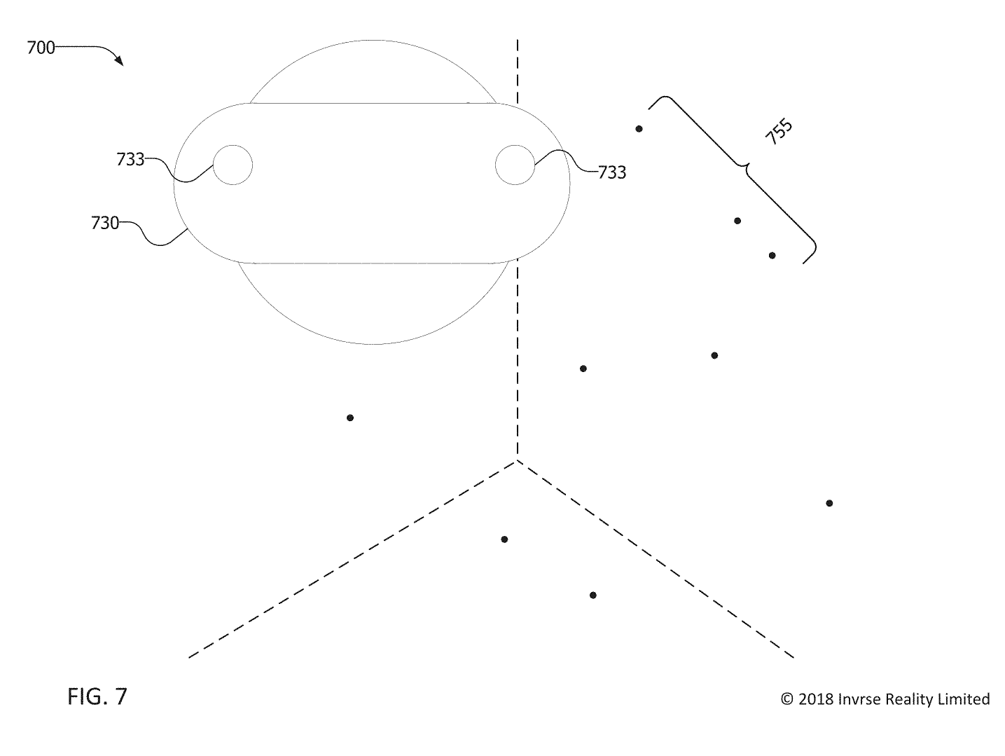

FIG. 7 is an example head mounted display 730 within a three-dimensional environment 700. The head mounted display 730 includes two cameras 733. The point cloud points 755 are representative of the way in which the head mounted display 730 views the environment. In the vast majority of cases, the points which strike the walls and reflect back are infrared or otherwise invisible to the naked human eye. But, they enable relatively high-quality depth sensing for a three-dimensional environment.

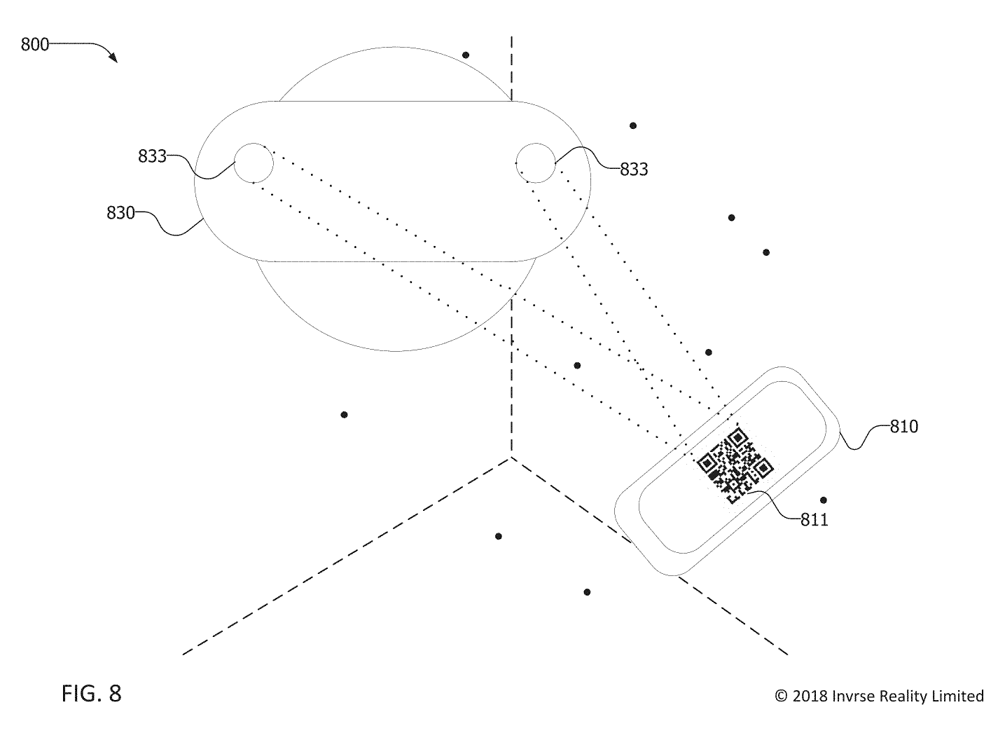

FIG. 8 is an example of a head mounted display 830 detecting a machine-readable image 811 on a mobile device 810. The machine-readable image 811 may be detected by the cameras 833 within the three-dimensional environment 800. The angle of the machine-readable image may be such that an orientation of the mobile device 810 is also discernable relatively easily.

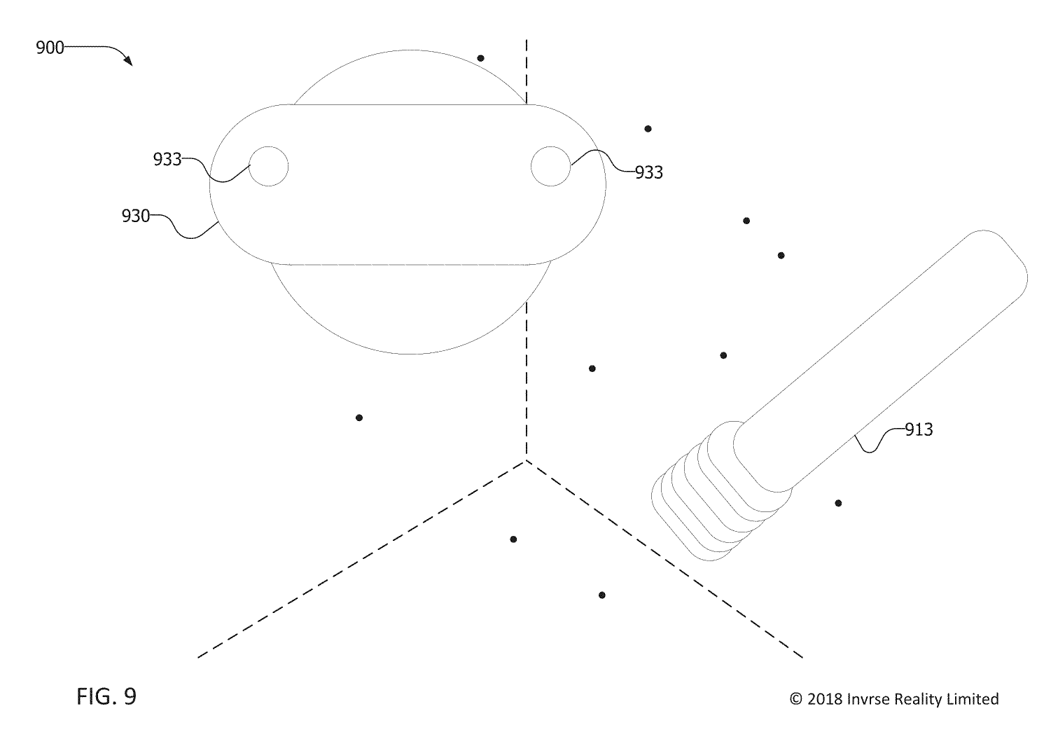

FIG. 9 is an example of a head mounted display 930 superimposing an image 913 over a mobile device within an augmented reality or virtual reality environment 900. The cameras 933 may continue to track the movement of the mobile device so that movements of the image 913 (which is a light saber in this example) may be superimposed and move as they would if they were real.

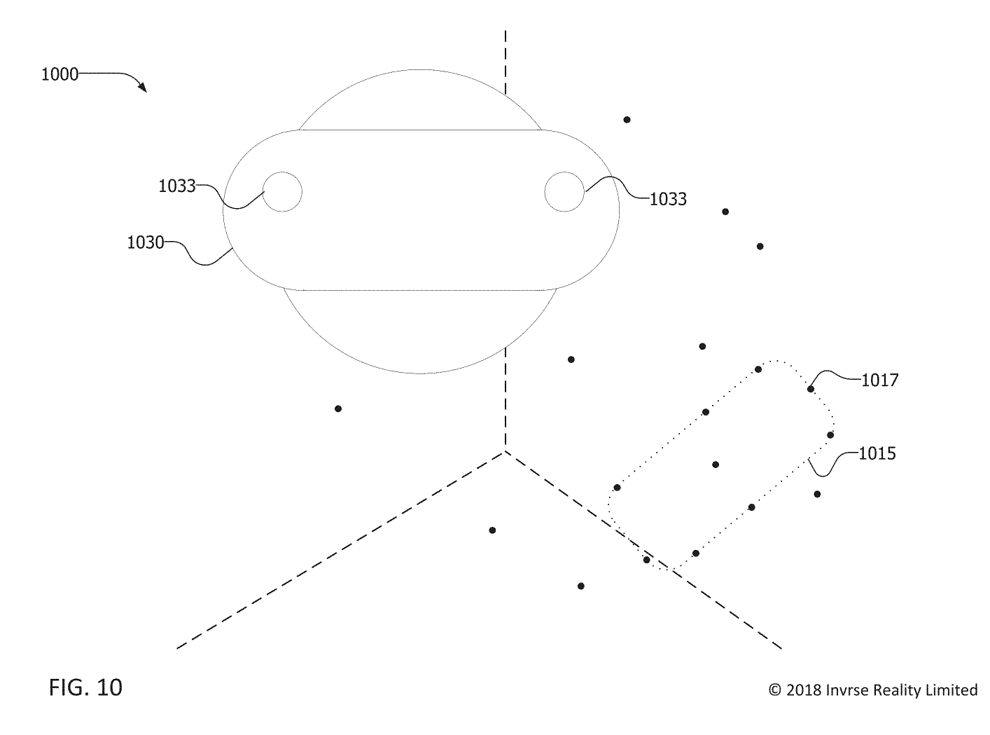

FIG. 10 is an example of a head mounted display 1030 integrating a mobile device 1015 into a point cloud. The mobile device 1015 may represented as a series of points within the point cloud based upon its detected orientation from the machine-readable image. One such point 1017 is shown. In this way, the mobile device 1015 ceases to be a mobile device, and is merely another set of three-dimensional points for the head mounted display to integrate into its point cloud. It may bear a label, suitable for identification as an individual device, so that it may be overlaid or otherwise interacted with by a user through occlusion or similar methods discussed above.

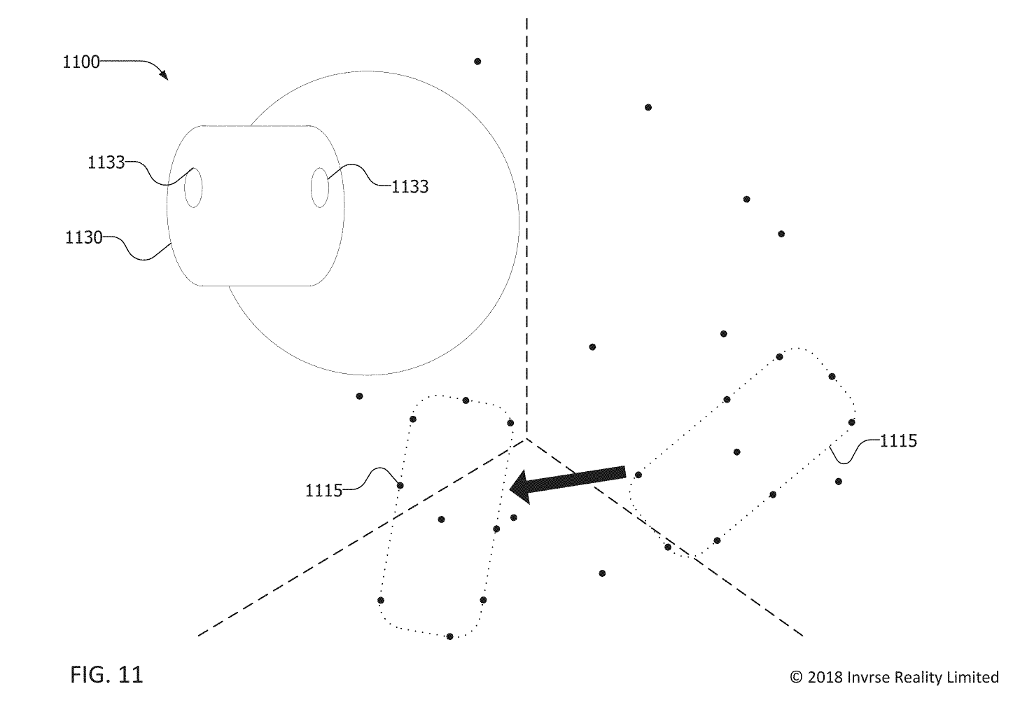

FIG. 11 is an example of updating a point cloud for a head mounted display using motion data from a mobile device 1115. The three-dimensional environment 1100 remains the same, but the head mounted display 1130 has turned such that the cameras 1133 can no longer see the display of the mobile device 1115. However, because the mobile device can communicate its motion data from its IMU to the head mounted display, its location within the point cloud may still be ascertained, even as it moves from position to position within the three-dimensional environment 1100. Once the head mounted display cameras can see the display of the mobile device 1115 again, the absolute position may be updated again. In the meantime, motion data may serve as an adequate stand-in for this data to perform tracking while the mobile device is not visible.

Closing Comments

Throughout this description, the embodiments and examples shown should be considered as exemplars, rather than limitations on the apparatus and procedures disclosed or claimed. Although many of the examples presented herein involve specific combinations of method acts or system elements, it should be understood that those acts and those elements may be combined in other ways to accomplish the same objectives. With regard to flowcharts, additional and fewer steps may be taken, and the steps as shown may be combined or further refined to achieve the methods described herein. Acts, elements and features discussed only in connection with one embodiment are not intended to be excluded from a similar role in other embodiments.

As used herein, “plurality” means two or more. As used herein, a “set” of items may include one or more of such items. As used herein, whether in the written description or the claims, the terms “comprising”, “including”, “carrying”, “having”, “containing”, “involving”, and the like are to be understood to be open-ended, i.e., to mean including but not limited to. Only the transitional phrases “consisting of” and “consisting essentially of”, respectively, are closed or semi-closed transitional phrases with respect to claims. Use of ordinal terms such as “first”, “second”, “third”, etc., in the claims to modify a claim element does not by itself connote any priority, precedence, or order of one claim element over another or the temporal order in which acts of a method are performed, but are used merely as labels to distinguish one claim element having a certain name from another element having a same name (but for use of the ordinal term) to distinguish the claim elements. As used herein, “and/or” means that the listed items are alternatives, but the alternatives also include any combination of the listed items.

It is claimed:

1. A system comprising:
a mobile device, comprising a first processor, a first memory, and a first display, the mobile device for displaying a machine-readable image on the first display;
a head mounted display device, comprising a second processor, a second display, a camera, and a second memory, the head mounted display device for:
using the camera to detect the machine-readable image on the first display at a first position;
calculating a first location of the mobile device, based upon the machine-readable image on the first display; and
integrating the first location of the mobile device into a point cloud for an area surrounding the head mounted display.

2. The system of claim 1 wherein the head mounted display device is further for:
detecting, using the camera, the machine-readable image on the first display at a second position;
calculating a new location of the mobile device, based upon the machine-readable image on the first display; and
recalibrating the new location of the mobile device into a point cloud for an area surrounding the head mounted display.

3. The system of claim 2 wherein each step is performed by the head mounted display device each time the machine-readable image on the first display is visible to the camera to periodically recalibrate a location for the mobile device relative to the head mounted display device.

4. The system of claim 2 wherein the mobile device is further for using at least one of a gravitometer, a LIDAR, an accelerometer, a gyroscope, and an integrated inertial measurement unit to estimate a position of the mobile device, relative to the head mounted display device when the first display is not visible to the camera of the head mounted display device.

5. The system of claim 4 wherein each step is performed by the head mounted display device each time the machine-readable image on the first display is visible to the camera to periodically recalibrate a location for the mobile device relative to the head mounted display device.

6. The system of claim 1 wherein the step of integrating the first location of the mobile device into the point cloud for the area surrounding the head mounted display comprises:
generating a set of three-dimensional points within the area, the set of three-dimensional points representative of the mobile device within the point cloud generated by the head mounted display device; and
providing to the mobile device one or more reference points from which the mobile device merges its own three-dimensional point cloud with the point cloud generated by the head mounted display device.

7. The system of claim 1 wherein the machine-readable image is interposed onto the first display every few seconds, and during time between interpositions, the first display appears to display unrelated content.

8. A non-volatile machine readable medium storing a program having instructions which when executed by a processor will cause the processor to:
use a camera to detect a machine-readable image on a first display of a mobile device at a first position;
calculate a first location of the mobile device, based upon the machine-readable image on the first display; and
integrate the first location of the mobile device into a point cloud for an area surrounding a head mounted display.

9. The medium of claim 8 wherein the instructions will further cause the processor to:
detect, using the camera, the machine-readable image on the first display at a second position;
calculate a new location of the mobile device, based upon the machine-readable image on the first display; and
recalibrate the new location of the mobile device into a point cloud for an area surrounding the head mounted display.

10. The medium of claim 9 wherein each step is performed by the processor each time the machine-readable image on the first display is visible to the camera to periodically recalibrate a location for the mobile device relative to the head mounted display device.

11. The medium of claim 8 wherein integrating the first location of the mobile device into the point cloud for the area surrounding the head mounted display comprises:
generating a set of three-dimensional points within the area, the set of three-dimensional points representative of the mobile device within the point cloud generated by the head mounted display device; and
providing to the mobile device one or more reference points from which the mobile device may merge its own three-dimensional point cloud with the point cloud generated by the head mounted display device.

12. The medium of claim 8 wherein the machine-readable image is interposed onto the first display every few seconds, and during time between interpositions, the first display appears to display unrelated content.

13. The apparatus of claim 8 further comprising:
the processor
a memory
wherein the processor and the memory comprise circuits and software for performing the instructions on the storage medium.

14. A method comprising:
displaying a machine-readable image on a first display of a mobile device;
using a camera to detect the machine-readable image on the first display at a first position;
calculating a first location of the mobile device, based upon the machine-readable image on the first display; and
integrating the first location of the mobile device into a point cloud for an area surrounding a head mounted display.

15. The method of claim 14 further comprising:
detecting, using the camera, the machine-readable image on the first display at a second position;
calculating a new location of the mobile device, based upon the machine-readable image on the first display; and
recalibrating the new location of the mobile device into a point cloud for an area surrounding the head mounted display.

16. The method of claim 15 wherein each step is performed each time the machine-readable image on the first display is visible to the camera to periodically recalibrate a location for the mobile device relative to the head mounted display device.

17. The method of claim 15 further comprising using at least one of a gravitometer, a LIDAR, an accelerometer, a gyroscope, and an integrated inertial measurement unit to estimate a position of the mobile device, relative to the head mounted display device in times when the first display is not visible to the camera of the head mounted display device.

18. The method of claim 17 wherein each step is performed by the head mounted display device each time the machine-readable image on the first display is visible to the camera to periodically recalibrate a location for the mobile device relative to the head mounted display device.

19. The method of claim 14 wherein the step of integrating the first location of the mobile device into the point cloud for the area surrounding the head mounted display comprises:
generating a set of three-dimensional points within the area, the set of three-dimensional points representative of the mobile device within the point cloud generated by the head mounted display device; and
providing to the mobile device one or more reference points from which the mobile device merges its own three-dimensional point cloud with the point cloud generated by the head mounted display device.

20. The method of claim 14 wherein the machine-readable image is interposed onto the first display every few seconds, and during time between interpositions, the first display appears to display unrelated content.
